(19) United States
(12) Patent Application Publication
(10) Pub. No.: US 2021/0005978 A1
(43) Pub. Date: Jan. 7, 2021

(54) ANTENNA ELEMENT AND ANTENNA ARRAY

(71) Applicant: Robert Bosch GmbH, Stuttgart (DE)

(72) Inventor: Mehran Pourmousavi, Leonberg (DE)

(21) Appl. No.: 16/766,770

(22) PCT Filed: Nov. 22, 2018
(86) PCT No.: PCT/EP2018/082296

§ 371 Date: May 26, 2020

(30) Foreign Application Priority Data
Jan. 18, 2018 (DE) 10 2018 200 758.6

(51) Int. Cl. H01Q 21/00; H01Q 9/04; H01Q 21/06; H01Q 9/16

(52) U.S. Cl. CPC H01Q 21/0075; H01Q 9/0407; H01Q 1/3233; H01Q 9/16; H01Q 21/065

(57) ABSTRACT

An antenna element having: a feed line for feeding in electrical power; and a first multiplicity of radiating elements situated on a first side of the feed line, and a second multiplicity of radiating elements situated on a second side of the feed line, the radiating elements being coupled in series to the feed line, being fed with electrical power by the feed line, and being designed to transmit electromagnetic radiation; the first multiplicity of radiating elements differing from the second multiplicity of radiating elements in a distribution of spatial dimensions of the radiating elements and/or in a distribution of distances of adjacent radiating elements.

### FIELD

The present invention relates to an antenna element and an antenna array.

### BACKGROUND INFORMATION

Radar devices enable a precise determination of relative speeds of objects, and, with the use of suitable modulation methods, of distances or angular positions of the objects as well. For this reason, radar devices are widely used in the automotive field.

In the gigahertz range, patch antennas are typically used. These can be provided on radiofrequency substrates particularly simply and at low cost. A metal surface whose length is approximately half the wavelength of the radar radiation is used here as a resonator.

The radiating element can be for example a single patch. Frequently, however, a better focusing of the radar radiation is required, i.e., an improved directional characteristic with narrower lobes. In panel antennas, a plurality of patches are therefore combined. In such an antenna array, all the patches are coupled to a common source that feeds electrical power into the patches. The coupling can be done in parallel or also in series using a power divider network.

U.S. Patent Application Publication No. US2007/0279303 A1 describes an antenna structure for antenna elements that are fed in series in this way. In order to improve the radiation characteristic, this document describes varying the distances between antenna elements or the dimensions of the antenna elements. For example, the distances between successive antenna elements can increase in the direction towards the end of a common feed line.

Typically, the antenna elements, or antennas, are designed in such a way that the main lobe, or main direction of transmission, of the transmitted radar radiation runs perpendicular to the substrate. In some applications, however, it can be advantageous to adapt the directional characteristic of the antennas so that the main direction of transmission does not run perpendicular to the substrate, but rather encloses a certain angle. In particular in radar devices that are positioned in the rear area of a vehicle or in the corner areas, such an adaptation of the directional characteristic may be advantageous.

A conventional mechanism for achieving strong directional effects is provided by phased array antennas. These are phase-controlled group antennas having a multiplicity of individual radiators configured in a matrix, in which a phase angle of the individual radiators is adjustable. Through suitable controlling, the transmission energy in the desired direction can be reinforced through constructive interference, and can be reduced or suppressed in undesired directions through destructive interference.

However, phased array antennas require relatively complicated mechanisms for the adaptation of the phases of the respective individual radiators. As a result, such antennas are typically relatively cost-intensive and complex to produce. Phased array technology is therefore frequently used in military applications, but its possible applications in the automotive field are rather limited.

There is therefore a need for low-cost antennas having directional effects that differ from the perpendicular direction.

### SUMMARY

The present invention provides an antenna element and an antenna array.

Preferred specific embodiments of the present invention are described herein.

According to a first aspect, the present invention provides an example antenna element having a feed line for feeding in electrical power. The antenna element further has a first multiplicity of radiating elements that are situated on a first side of the feed line. In addition, the antenna element has a second multiplicity of radiating elements that are situated on a second side of the feed line. The radiating elements are coupled in series to the feed line, and are fed with electrical power by the feed line. The radiating elements are in addition designed to transmit electrical radiation. The first multiplicity of radiating elements differs from the second multiplicity of radiating elements in a distribution of spatial dimensions of the radiating elements and/or in a distribution of distances between adjacent radiating elements.

According to a second aspect, the present invention provides an antenna array having a multiplicity of antenna elements that are fed in common.

Through the use of radiating elements having different distributions of the spatial dimensions, or distances, a desired directional effect can be achieved even for a single antenna element. The constructive and destructive interference of the transmitted radar waves are responsible for this. Because the radiating elements are differently distributed on the two sides of the feed line, as a sum there results a main lobe that differs from the perpendicular direction of the substrate. In this way, a highly sensitive antenna can be provided.

In addition, additional measures for forming the radar beams, in particular pins and reactive elements, which can negatively influence the radiated power, can be omitted. In comparison with phased array antennas, the antenna element is further distinguished by a compact construction, because additional phase dividers can be omitted. This is advantageous in particular in automotive applications, where the available spaces must be optimally exploited.

Because an additional phase controlling by a phase divider is not required, a particularly low-cost antenna having a specified directional characteristic can be provided.

“Spatial dimensions” can be understood as referring to a width and a length of the corresponding radiating element, for rectangular patches or radiating elements. For radiating elements that are not rectangular in design, the spatial dimensions can be understood for example as the diameters or surface areas of the radiating elements.

A distribution of the spatial dimensions is to be understood as the sequence of the dimensions along the feed line. “Different distributions” thus preferably means not only that the radiating elements are configured offset to one another on the two sides of the feed line, but also that, at at least one location, the sequences of the distances or dimensions of the radiating elements on one side cannot be brought into agreement with corresponding sequences of the distances or dimensions of the radiating elements on the other side.

Preferably, the antenna element is a panel antenna that is situated in planar fashion on a substrate.

Through the suitable choice of the dimensions of, and the distances between, the radiating elements, an adequately high level of radiated power can be achieved in a wide angular region.

According to a preferred development of the antenna element according to the present invention, the distributions of the dimensions and/or distances include a Dolph-Chebyschev distribution, a uniform distribution, and/or a binomial distribution.

According to a development of the antenna element according to the present invention, the radiating elements of the first multiplicity and/or of the second multiplicity of the radiating elements are realized as slotted patches.

According to a preferred development of the antenna element according to the present invention, the radiating elements are coupled to the feed line via striplines. According to further specific example embodiments, however, the radiating elements can also be coupled to the feed line by capacitive couplings and/or slot couplings.

According to a further development of the antenna element according to the present invention, the antenna element is designed as a dipole antenna element.

According to a preferred development of the antenna element according to the present invention, the feed line and/or the radiating elements are designed as strip elements. The antenna element can thus be in particular a stripline antenna element.

According to a preferred development of the antenna element according to the present invention, the first multiplicity of radiating elements is configured so as to be offset relative to the second multiplicity of radiating elements along the feed line.

According to a specific embodiment of the antenna element according to the present invention, the distances between the radiating elements on both sides can be constant or can have the same distribution, while the distributions of the dimensions differ.

According to a further specific embodiment of the antenna element according to the present invention, the dimensions of the radiating elements on both sides can be constant or can have the same distribution, while the distributions of the distances between successive antenna elements for the two sides, i.e., for the first multiplicity of radiating elements and the second multiplicity of radiating elements, differ.

According to a preferred development of the antenna element according to the present invention, the at least one radiating element of the first multiplicity of radiating elements differs from all the radiating elements of the second multiplicity of radiating elements in the width and/or in the distance to an adjacent radiating element of the first multiplicity of radiating elements.

According to a preferred further development of the antenna element according to the present invention, the distributions of the dimensions and/or distances are selected in such a way that a radiation maximum of the transmitted electromagnetic radiation occurs at a direction of radiation that differs from a perpendicular direction.

### BRIEF DESCRIPTION OF THE DRAWINGS

FIG. 1 shows a schematic top view of an antenna element according to a specific embodiment of the present invention.

FIG. 2 shows an illustration of the radiated power as a function of the angle of radiation for the antenna element shown in FIG. 1.

FIG. 3 shows a schematic top view of an antenna element according to a further specific embodiment of the present invention.

FIG. 4 shows a schematic top view of an antenna array according to a specific embodiment of the present invention.

FIG. 5 shows an illustration of the radiated power as a function of the angle of radiation for the antenna array shown in FIG. 4.

In all Figures, identical or functionally identical elements and devices are provided with the same reference characters.

### DETAILED DESCRIPTION OF EXAMPLE EMBODIMENTS

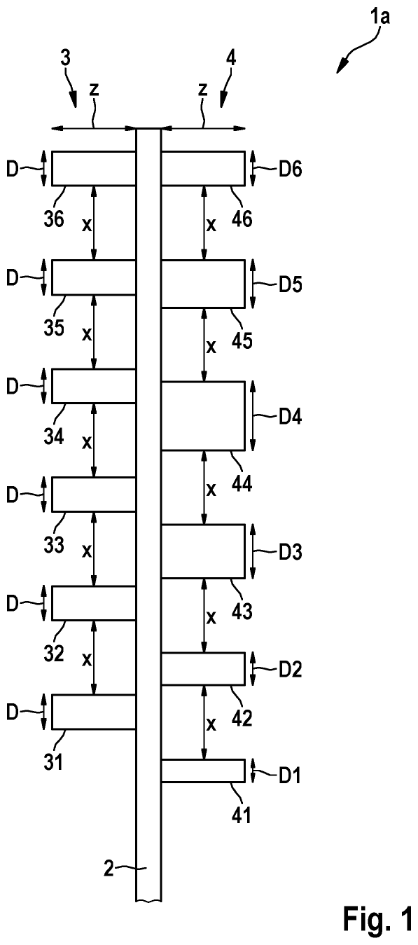

FIG. 1 illustrates an example of an antenna element 1a in accordance with an example embodiment of the present invention. Antenna element 1a is realized as a panel antenna element that is fashioned on a substrate (not shown). Antenna element 1a can be realized as a radar transmitter device or as a radar receiver device. Antenna element 1a can also be an element of an antenna array.

Antenna element 1a has a feed line 2 that runs in a straight line, realized as a stripline. However, the present invention is not limited to this. Thus, feed line 2 need not necessarily run in a straight line.

Feed line 2, planar in design, has radiating elements 31 to 36 and 41 to 46 situated on a first, or left, side of feed line 2 and on a second, or right, side of feed line 2. Radiating elements 31 to 36 and 41 to 46 are realized as patches that are connected or coupled directly to feed line 2.

However, the present invention is not limited to such an embodiment. Thus, radiating elements 31 to 36 and 41 to 46 can be coupled to the feed line via coupling elements, such as strip elements connected to feed line 2. According to further specific embodiments, radiating elements 31 to 36 and 41 to 46 can also be coupled to feed line 2 via capacitive couplings and/or slot couplings.

Electrical power is fed to radiating elements 31 to 36 and 41 to 46 via feed line 2. Radiating elements 31 to 36 and 41 to 46 are in this way excited so as to transmit electromagnetic waves, preferably radar radiation. In particular, antenna element la can be designed to transmit radar waves in the gigahertz range, in particular for operation in the 77 gigahertz frequency band, which is widely used in automotive applications.

Radiating elements 31 to 36 and 41 to 46 can be subdivided into a first multiplicity 3 of radiating elements 31 to 36 on the left, or first, side of feed line 2 and a second multiplicity 4 of radiating elements 41 to 46 on the right, or second, side of feed line 2. In each case, the first multiplicity 3 of radiating elements 31 to 36, or the second multiplicity 4 of radiating elements 41 to 46, are coupled in series to feed line 2.

In the embodiment shown in FIG. 1, first multiplicity 3 of radiating elements 31 to 36 differs from second multiplicity 4 of radiating elements 41 to 46 in the distribution of the widths of radiating elements 31 to 36 and 41 to 46. Both radiating elements 31 to 36 of first multiplicity 3 of radiating elements 31 to 36 and radiating elements 41 to 46 of second multiplicity 4 of radiating elements 41 to 46 are realized in rectangular fashion and have identical length z, which is measured orthogonally to feed line 2. In addition, the distances x between successive radiating elements 31 to 36 and 41 to 46 are identical in each case. The distances x preferably correspond to the wavelength of the transmitted radar radiation.

Widths D of radiating elements 31 to 36 of first multiplicity 3 of radiating elements 31 to 36 are fixed in each case. Here, widths D are measured parallel to feed line 2. First multiplicity 3 of radiating elements 31 to 36 thus has a uniform distribution of the widths.

Widths D1 to D6 of radiating elements 41 to 46 of second multiplicity 4 of radiating elements 41 to 46 follow a Dolph-Chebyschev distribution. The ratio of widths D1 to D6 thus corresponds to the ratio of Chebyschev polynomials. According to a further specific embodiment, widths D1 to D6 can follow any other distribution, for example a binomial distribution. The radiation characteristic of antenna element 1a can be set via the choice of suitable distributions.

According to further specific embodiments, in addition or alternatively the lengths z of radiating elements 31 to 36 and 41 to 46 can vary. Preferably, the distribution of the lengths z of first multiplicity 3 of radiating elements 31 to 36 differs from the distribution of the lengths z of second multiplicity 4 of radiating elements 41 to 46.

According to further specific embodiments, in addition or alternatively the distances x between successive radiating elements 31 to 36 and 41 to 46 can vary. Preferably, the distribution of the distances x of first multiplicity 3 of radiating elements 31 to 36 differs from the distribution of the distances x of second multiplicity 4 of radiating elements 41 to 46.

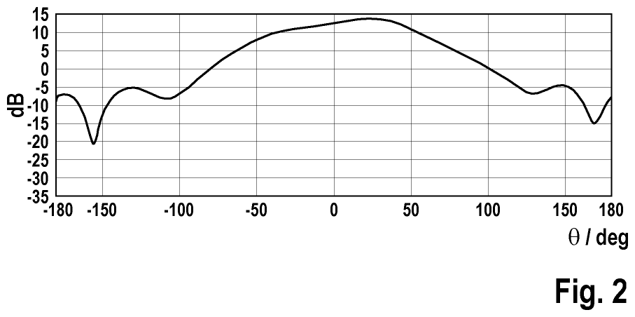

FIG. 2 illustrates a radiated power of antenna element 1a, shown in FIG. 1, as a function of an azimuth angle θ. It will be seen that the radiation characteristic has a maximum at an angle that differs from 0°, i.e., the main direction of radiation does not run perpendicular to the substrate. As a result, antenna element la is particularly well-suited for applications in the automotive area, for example in the front or rear edge or corner region.

As FIG. 2 shows, a main direction of radiation can be achieved at an azimuth angle of approximately 25°. In addition, a high degree of stability of the radiation pattern can be achieved, such that the direction of radiation and the radiated power remain substantially constant in a bandwidth of approximately 3 gigahertz. In addition, a high radiated power can be achieved in a large angular range having a width of approximately 90° even after changing the direction of radiation. In addition, a good side lobe level can be achieved in the elevation plane, such that, in a band 3 gigahertz in width around a frequency of 76.5 gigahertz, substantially no change occurs in the main direction of radiation.

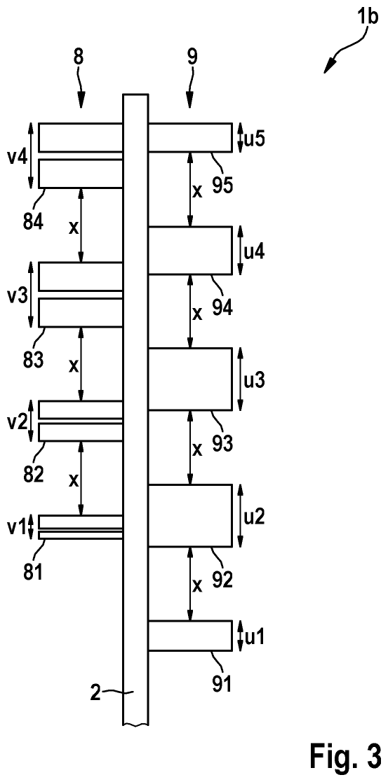

FIG. 3 shows an antenna element 1b according to a further specific embodiment of the present invention. Antenna element 1b has a first multiplicity 8 of radiating elements 81 to 84, where the widths v1 to v4 of radiating elements 81 to 84 follow a binomial distribution. Radiating elements 81 to 84 are each realized as slot radiating elements. In addition, antenna element 1b has a second multiplicity 9 of radiating elements 91 to 95, where widths u1 to u5 follow a Dolph-Chebyschev distribution. The distances x between successive radiating elements 81 to 84 and 91 to 95 are constant in each case.

The radiating elements of first multiplicity 8 and second multiplicity 9 are configured slightly offset to one another due to the different widths, in order to correspondingly adjust the phase.

Preferably, the width of the radiating elements decreases in each case towards the edge of feed line 2, as is illustrated for second multiplicity 4 of radiating elements 41 to 46 of antenna element la shown in FIG. 1, and for first multiplicity 8 and second multiplicity 9 of radiating elements of antenna element 1b shown in FIG. 3.

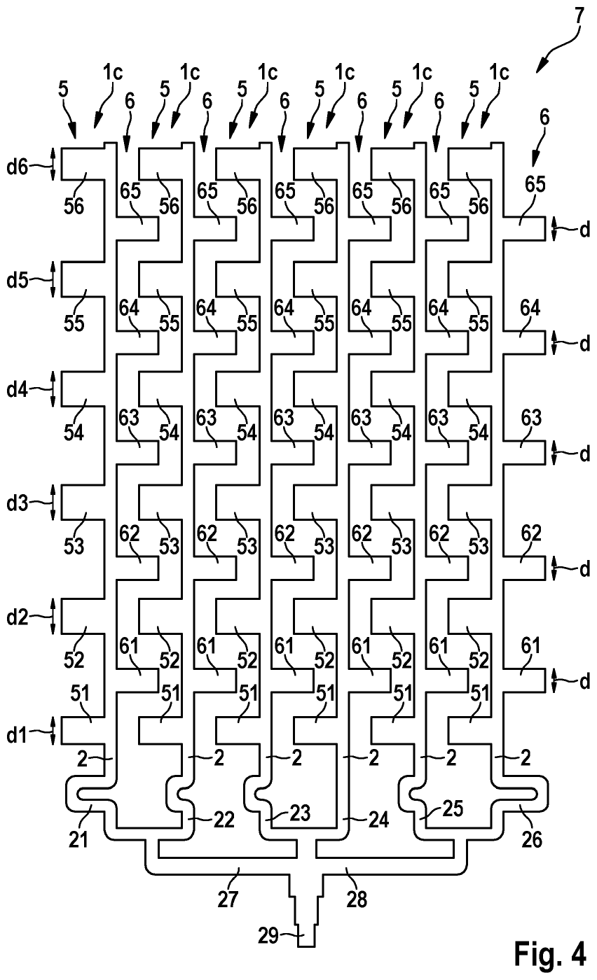

FIG. 4 illustrates an example antenna array 7 according to the present invention. The antenna array has six antenna elements 1c, each having a first multiplicity 5 of radiating elements 51 to 56 having binomially distributed widths d1 to d6, and a second multiplicity 6 of radiating elements 61 to 65 having constant widths d.

Antenna elements 1c are each connected in pairs, via first to sixth striplines 21 to 26, to seventh and eighth striplines 27, 28, which are coupled to a ninth stripline 29. Electrical energy can be coupled into the respective striplines 2 of individual antenna elements 1c via ninth stripline 29. Phase differences between the individual antenna elements 1c can be achieved via differently selected lengths of first to sixth striplines 21 to 26, and in this way a suitable radiation characteristic can be achieved.

Instead of antenna elements 1c shown in FIG. 4, any antenna elements having unequally distributed radiating elements can be used, in particular antenna elements 1a, 1b shown in FIGS. 1 and 3.

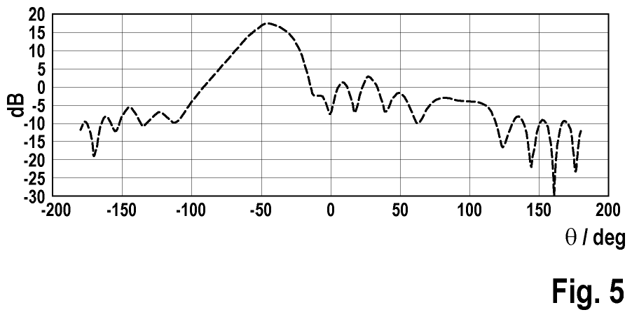

FIG. 5 illustrates the radiated power of antenna array 7, shown in FIG. 4, as a function of the azimuth angle θ. The radiation characteristic has a maximum at a value of −45°. The achievable maximum is in addition significantly more pronounced than would be the case with the use of antenna elements having equally distributed radiating elements.

1-10. (canceled)

11. An antenna element, comprising:
a feed line configured to feed in electrical power;
a first multiplicity of radiating elements situated on a first side of the feed line; and
a second multiplicity of radiating elements situated on a second side of the feed line;
wherein the first and second multiplicity of radiating elements are coupled in series to the feed line, are fed with electrical power by the feed line, and are configured to transmit electromagnetic radiation; and
wherein the first multiplicity of radiating elements differ from the second multiplicity of radiating elements in a distribution of spatial dimensions of radiating elements and/or in a distribution of distances of adjacent radiating elements.

12. The antenna element as recited in claim 11, wherein the distribution of the spatial dimensions and/or the distribution of distances include a Dolph-Chebyschev distribution, and/or a uniform distribution, and/or a binomial distribution.

13. The antenna element as recited in claim 11, wherein radiating elements of the first multiplicity of radiating elements and/or radiating elements of the second multiplicity of radiating elements are slotted patches.

14. The antenna element as recited in claim 11, the first and second multiplicity of radiating elements are coupled to the feed line via striplines, and/or capacitive couplings, and/or slot couplings.

15. The antenna element as recited in claim 11, wherein the antenna element is a dipole antenna element.

16. The antenna element as recited in claim 11, wherein the feed line and the first and second multiplicity of radiating elements are as strip elements.

17. The antenna element as recited in claim 11, wherein the first multiplicity of radiating elements are arranged so as to be offset relative to the second multiplicity of radiating elements along the feed line.

18. The antenna element as recited in claim 11, wherein at least one radiating element of the first multiplicity of radiating elements differs from all radiating elements of the second multiplicity of radiating elements in the width and/or in a distance to an adjacent radiating element of the first multiplicity of radiating elements.

19. The antenna element as recited in claim 11, wherein the distribution of the spatial dimensions and/or distances are selected such that a radiated maximum of transmitted electromagnetic radiation occurs at a direction of radiation that differs from a perpendicular direction.

20. An antenna array, comprising:
a multiplicity of antenna elements, each of the antenna elements including:
a feed line configured to feed in electrical power;
a first multiplicity of radiating elements situated on a first side of the feed line; and
a second multiplicity of radiating elements situated on a second side of the feed line;
wherein the first and second multiplicity of radiating elements are coupled in series to the feed line, are fed with electrical power by the feed line, and are configured to transmit electromagnetic radiation; and
wherein the first multiplicity of radiating elements differ from the second multiplicity of radiating elements in a distribution of spatial dimensions of radiating elements and/or in a distribution of distances of adjacent radiating elements.
